(19) United States
(12) Patent Application Publication
(10) Pub. No.: US 2008/0230018 A1
(43) Pub. Date: Sep. 25, 2008

(54) OCTANE NUMBER-INCREASING CATALYST, FUEL REFORMER OF INTERNAL COMBUSTION ENGINE, AND THE INTERNAL COMBUSTION ENGINE

(75) Inventor: Chiaki KOBAYASHI, Yokosuka-shi (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 12/043,411

(22) Filed: Mar. 6, 2008

(30) Foreign Application Priority Data
Mar. 19, 2007 (JP) 2007-070470

(51) Int. Cl. F02B 43/00; C22C 27/00; B01J 21/08; B01J 21/04; B01J 23/10; B01J 21/06; B01J 21/00; B01J 21/10; B01J 23/40

(52) U.S. Cl. 123/3; 420/462; 502/304; 502/261; 502/325; 502/328; 502/332

(57) ABSTRACT

A fuel reformer of an internal combustion engine includes: an octane number-increasing catalytic device including an octane number-increasing catalyst; and an oxygen supply device that supplies oxygen to the octane number-increasing catalytic device. The octane number-increasing catalyst includes rhodium and increases an octane number of liquid-phase fuel under presence of oxygen. The fuel reformer can enhance combustion characteristics of the internal combustion engine

### BACKGROUND OF THE INVENTION

1. Field of the Invention

The present invention relates to an octane number-increasing catalyst, a fuel reformer of an internal combustion engine, and the internal combustion engine. More specifically, the present invention relates to an octane number-increasing catalyst that increases an octane number of liquid-phase fuel under the presence of oxygen, to a fuel reformer including the catalyst, and to an internal combustion engine including the fuel reformer.

2. Description of the Related Art

Heretofore, an internal combustion engine has been proposed which includes: a reformer reforming liquid fuel to produce hydrogen and reformed fuel containing high octane number component; a device which supplies the reformed fuel to the internal combustion engine; and a device which supplies the separated hydrogen to a fuel cell (see Japanese Patent Unexamined Publication No. 2003-184666).

Moreover, another internal combustion engine has been proposed which includes: a reformer reforming liquid fuel to produce reformed liquid fuel with a high octane number and hydrogen-rich reformed gas fuel; a gas-liquid separator which separates the reformed liquid fuel and gas fuel; and a device which supplies the reformed liquid fuel to the internal combustion engine (see Japanese Patent Unexamined Publication No. 2003-184667).

### BRIEF SUMMARY OF THE INVENTION

However, in vehicles described in Japanese Patent Unexamined Publications No. 2003-184666 and No. 2003-184667, there has been a problem that combustion characteristics such as suppression of knocking are not sufficient.

The present invention has been made in consideration for the problem inherent in the conventional technologies. It is an object of the present invention to provide an octane number-increasing catalyst capable of enhancing the combustion characteristics, a fuel reformer including the catalyst, and an internal combustion engine including the fuel reformer.

According to one aspect of the present invention, there is provided an octane number-increasing catalyst, wherein the octane number-increasing catalyst increases an octane number of liquid-phase fuel under presence of oxygen.

### BRIEF DESCRIPTION OF THE SEVERAL VIEWS OF THE DRAWING

FIG. 1 is a schematic view showing an example of an octane number-increasing catalyst according to the present invention.

FIG. 2 is schematic views showing a state where the octane number-increasing catalyst is applied to a honeycomb substrate.

FIGS. 3A and 3B are schematic views showing configurations of a first embodiment of an internal combustion engine according to the present invention.

FIG. 4 is a schematic view showing a configuration of a second embodiment of the internal combustion engine according to the present invention.

FIG. 5 is a schematic view showing a configuration of a third embodiment of the internal combustion engine according to the present invention.

FIG. 6 is a schematic view showing a configuration of a fourth embodiment of the internal combustion engine according to the present invention.

FIG. 7 is a schematic view showing a configuration of a fifth embodiment of the internal combustion engine according to the present invention.

FIG. 8 is a schematic view showing a part of a configuration of a sixth embodiment of the internal combustion engine according to the present invention.

FIG. 9 is a flowchart explaining an example of an oxygen supply amount control in the sixth embodiment.

FIG. 10A is a graph showing relationships between gas components and a catalyst inlet temperature in a case where oxygen is not supplied to the catalyst in Examples.

FIG. 10B is a graph showing relationships between the gas components and the catalyst inlet temperature in a case where oxygen is supplied to the catalyst in Examples.

### DETAILED DESCRIPTION OF THE INVENTION

A description will be made in detail of an octane number-increasing catalyst of the present invention by using the drawings. Note that, in the drawings to be explained below, the same reference numerals will be assigned to ones having the same functions, and repeated descriptions thereof will be omitted.

The octane number-increasing catalyst of the present invention is one that increases an octane number (a value representing anti-knocking characteristics of fuel in a spark-ignition engine) of liquid-phase fuel under the presence of oxygen. A fuel reformer of an internal combustion engine, which includes the octane number-increasing catalyst of the present invention, can increase the octane number of the liquid-phase fuel, and can enhance such combustion characteristics of the internal combustion engine. Moreover, the fuel reformer is capable of using air, which contains oxygen, as reaction gas-cum-carrier gas, and also exerts a secondary effect of facilitating the fuel reformer itself to be mounted on a vehicle.

Note that such a catalyst that increases the octane number of the fuel has been heretofore present. However, when oxygen is present under an atmosphere to reform the fuel, a reaction of accelerating oxidation of the fuel undesirably precedes a reaction of increasing the octane number of the fuel, and it has been difficult to efficiently increase the octane number of the fuel. However, in the present invention, rhodium is used as a catalyst component as will be described later, and further, oxygen is supplied to the atmosphere to reform the fuel, whereby the octane number can be increased efficiently.

Here, in this application of the invention, the “liquid-phase fuel” refers to hydrocarbon fuel, which maintains a liquid state at ordinary temperature and normal pressure (25° C., 1 atm), such as light oil (gas oil), gasoline, and alcohol fuel including biomass ethanol and the like. Meanwhile, as “gas-phase fuel”, there can be mentioned ones, in which carbon numbers are 1 to 4, such as hydrogen, methane, ethane, ethylene, propane, propylene, and butane. Here, the “gas-phase fuel” refers to low-molecular-weight hydrocarbon that maintains a gas state at the ordinary temperature and the normal pressure. In the above-described example, the “gas-phase fuel” is hydrocarbon fuel excluding the hydrogen.

Moreover, in paraffins, octane numbers thereof are generally higher as molecular weights are smaller and side chains are larger. Moreover, octane numbers of olefins are higher than those of the paraffins, and aromatic hydrocarbons exhibit higher octane numbers, which are 100 to 120 as research octane numbers (RONs). Hence, the octane number-increasing catalyst in the present invention refers to a catalyst that increases the octane number by changing components of the liquid-phase fuel in the course where the liquid-phase fuel passes through the catalyst, for example, by converting the paraffins into the olefins, converting the olefins into the aromatic hydrocarbons, and so on.

It is desirable that the octane number-increasing catalyst of the present invention contain rhodium. With such a configuration, the octane number of the liquid-phase fuel can be increased more under such an oxygen atmosphere. Moreover, the fuel reformer of the internal combustion engine, which includes the octane number-increasing catalyst, can increase the octane number of the liquid-phase fuel more, and can enhance the combustion characteristics of the internal combustion engine more.

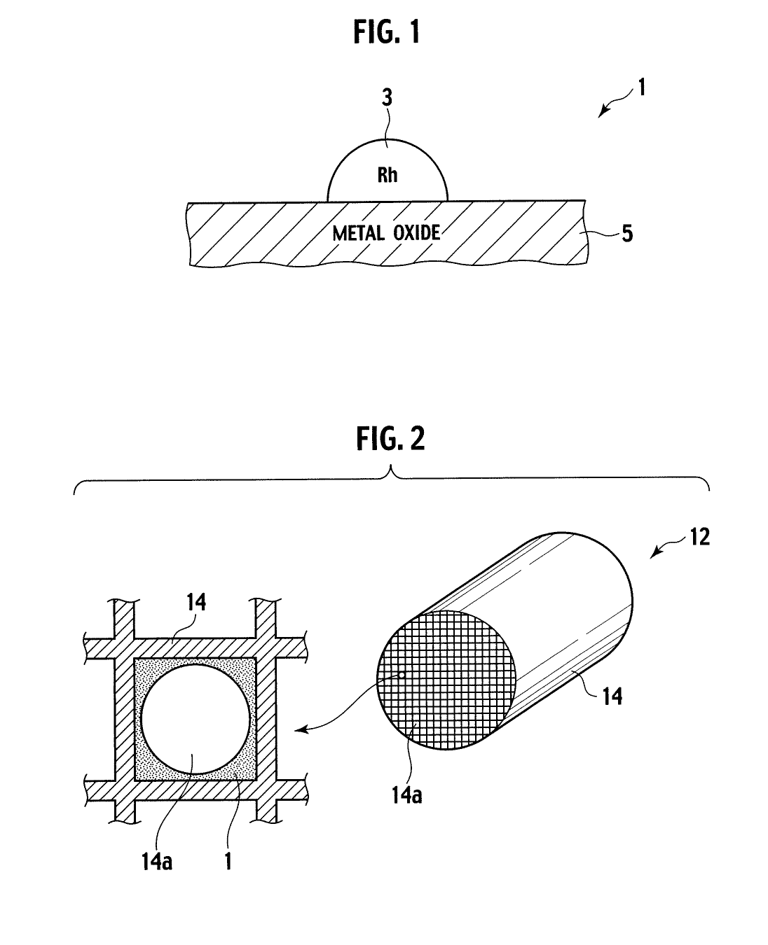

As the octane number-increasing catalyst of the present invention, there is mentioned, as shown in FIG. 1, a catalyst 1 that contains rhodium 3 and a base material 5 composed of a metal oxide that is any of silica, alumina, ceria, zirconia, titania, magnesia, and an arbitrary combination thereof, in which particles of rhodium 3 are supported on the base material. Moreover, as the octane number-increasing catalyst, there can be mentioned a metal oxide that contains rhodium and the metal oxide that is any of silica, alumina, ceria, zirconia, titania, magnesia, and the arbitrary combination thereof, in which rhodium and the metal oxide are solid-solved to form a composite oxide. However, the octane number-increasing catalyst of the present invention is not limited to these as long as rhodium is contained therein.

Here, as a production method of the catalyst 1 of FIG. 1, first, powder of the metal oxide is mixed with a solution of rhodium (a rhodium nitrate solution and the like), followed by stirring, and a resultant solution is thereafter heated and dried. In such a way, powder of the catalyst 1, in which rhodium is supported on surfaces of the metal oxide, can be obtained.

Moreover, it is preferable that the octane number-increasing catalyst of the present invention be one in which the catalyst 1 of FIG. 1 is coated on an inside of a monolith substrate. Specifically, as the octane number-increasing catalyst, it is preferable to use one in which the catalyst 1 is coated on inner walls of a monolith substrate 14 including a plurality of cells 14a. In such a way, a contact area between the liquid-phase fuel and the catalyst 1 is increased to a large extent, and the octane number of the liquid-phase fuel can be increased efficiently.

Next, a description will be made of the fuel reformer of the present invention. The fuel reformer of the present invention is a fuel reformer of an internal combustion engine that operates accompanied with generation of heat. Moreover, the fuel reformer is one including an octane number-increasing catalytic device and an air supply device (oxygen supply device). Here, the octane number-increasing catalyst increases the octane number of the liquid-phase fuel under the presence of oxygen, and the air supply device supplies air (oxygen) to the octane number-increasing catalytic device. With such a configuration, the octane number of the liquid-phase fuel can be increased more, and the combustion characteristics of the internal combustion engine including the fuel reformer can be enhanced.

Moreover, in the fuel reformer of the present invention, it is preferable that the air supply device be one that supplies oxygen to the octane number-increasing catalytic device so that a ratio of the number of oxygen molecules with respect to the number of molecules of the liquid-phase fuel (that is, number of oxygen molecules/number of molecules of liquid-phase fuel) can be within a range from 0.005 to 1.0. When the ratio is less than 0.005, the octane number cannot sometimes be increased, and when the ratio exceeds 1.0, the liquid-phase fuel is sometimes burned.

Furthermore, it is preferable that the fuel reformer of the present invention be one including: a gas-liquid separator that separates raw fuel into the gas-phase fuel and the liquid-phase fuel; and a molecular weight-increasing catalytic device that has a molecular weight-increasing catalyst increasing a molecular weight of the gas-phase fuel, in which the octane number-increasing catalytic device and the molecular weight-increasing catalyst are provided downstream of the gas-liquid separator. With such a configuration, the molecular weight of the gas-phase fuel can be increased, thus making it possible to enhance the combustion characteristics more, for example, to enable suppression of knocking, and the like. Here, the “molecular weight increase” refers to that the molecular weight of the gas-phase fuel is increased in the course where the gas-phase fuel passes through the molecular weight-increasing catalyst.

Moreover, in the fuel reformer of the present invention, it is desirable that one, which is any of a carbon dioxide detector, a carbon monoxide detector, an aldehyde detector, and an arbitrary combination thereof, be provided downstream of the octane number-increasing catalytic device. With such a configuration, the octane number of the liquid-phase fuel can be increased efficiently. As the carbon dioxide detector, for example, there can be applied a carbon dioxide detector of an infrared absorption type, and a carbon dioxide detector of a solid electrolyte type. Either one or both of the carbon dioxide detectors can be used.

Moreover, it is desirable that the fuel reformer of the present invention be one configured so that the air supply device can reduce an air supply amount when the carbon dioxide detector placed downstream of the catalytic device determines that a concentration of detected carbon dioxide has reached a preset limit carbon dioxide concentration (C*). With such a configuration, a burnout of the liquid-phase fuel owing to excessive oxidation thereof can be prevented, and accordingly, the octane number of the liquid-phase fuel can be enhanced efficiently. Moreover, in the fuel reformer of the present invention, the above-described limit carbon dioxide concentration is preferably 3 vol % or less, and more preferably 1 vol % or less on an outlet side of the octane number-increasing catalyst. When the limit concentration of the carbon dioxide exceeds 3 vol %, the combustion of the liquid-phase fuel is sometimes accelerated.

Furthermore, it is preferable that the fuel reformer of the present invention be one including a temperature sensor on a downstream side of the octane number-increasing catalytic device. In the fuel reformer, an exothermic reaction and an endothermic reaction sometimes progress concurrently or sequentially in an inside of the catalyst. Accordingly, it is preferable that the fuel reformer include the temperature sensor in order to monitor excessive reactions. A thermocouple can be used as the temperature sensor.

Still further, it is preferable that the fuel reformer of the present invention be one including a heat exchanger that collects the heat generated by the internal combustion engine and heats the octane number-increasing catalytic device. In such a way, energy efficiency of the entire system can be enhanced since waste heat can be collected, and in addition, a secondary effect of enabling miniaturization of the fuel reformer is also exerted. Note that, in the present invention, it is defined that the heat generated by the internal combustion engine includes heat generated by an exhaust system thereof, and that the exhaust system includes an exhaust catalytic converter and the like, which are provided therein.

Next, a description will be made of the internal combustion engine of the present invention. As described above, the internal combustion engine is one including the fuel reformer of the present invention. With such a configuration, the internal combustion engine becomes one in which the combustion characteristics are enhanced, for example, the knocking is suppressed.

Next, a description will be made of embodiments of the internal combustion engine of the present invention by using the drawings.

### First Embodiment

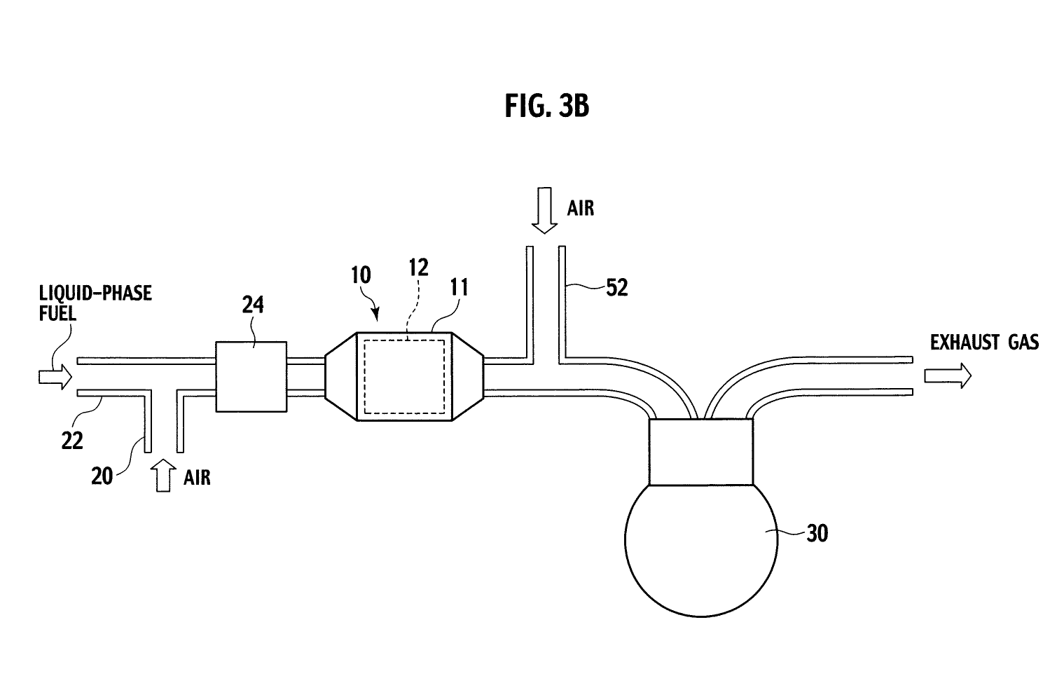

FIG. 3A is a schematic view showing a configuration of a first embodiment of the internal combustion engine in the present invention. As shown in FIG. 3, the internal combustion engine of this embodiment includes: an octane number-increasing catalytic device 10 having an octane number-increasing catalyst 12 that increases the octane number of the liquid-phase fuel under the presence of oxygen; a first air passage 20 as a part of the air supply device that supplies oxygen to the octane number-increasing catalytic device; and an engine 30 as an example of the internal combustion engine. The octane number-increasing catalytic device 10 includes: the octane number-increasing catalyst 12; and a casing 11 that holds the octane number-increasing catalyst 12 in an inside thereof. Moreover, the octane number-increasing catalytic device 10 is provided on a liquid-phase fuel passage 22 that allows the engine 30 to communicate with a fuel tank 40 to be described later. Moreover, a vaporizer 24 that vaporizes the liquid-phase fuel is provided on an upstream side of the octane number-increasing catalytic device 10 and on the liquid-phase fuel passage 22. As the vaporizer 24, an injector that sprays and vaporizes the liquid-phase fuel can be used. Moreover, the first air passage 20 is connected to a part of the liquid-phase fuel passage 22, which is located between the vaporizer 24 and the octane number-increasing catalytic device 10. Furthermore, a second air passage 52 is connected to a part of the liquid-phase fuel passage 22, which is located between the octane number-increasing catalytic device 10 and the engine 30.

A description will be made of actions of this embodiment. In the internal combustion engine of this embodiment, first, the liquid-phase fuel is supplied through the liquid-phase fuel passage 22 to the vaporizer 24. Then, the liquid-phase fuel is vaporized by the vaporizer 24, and thereafter, is supplied to the octane number-increasing catalytic device 10. Moreover, the air (oxygen) is supplied to the octane number-increasing catalytic device 10 from the first air passage 20. The supplied liquid-phase fuel and oxygen contact rhodium of the octane number-increasing catalyst 12, whereby the liquid-phase fuel is converted, and the octane number thereof is increased. The liquid-phase fuel of which octane number is increased is mixed with the air supplied from the second air passage 52, and is then supplied to the engine 30. In the internal combustion engine of this embodiment, the octane number of the liquid-phase fuel is increased by the octane number-increasing catalytic device 10. Accordingly, the knocking can be suppressed, thus making it possible to enhance the combustion characteristics.

Note that, in FIG. 3A, the vaporizer 24 is provided on an upstream side of a connection portion between the first air passage 20 and the liquid-phase fuel passage 22. However, in this embodiment, as shown in FIG. 3B, the vaporizer 24 may be provided between the octane number-increasing catalytic device 10 and the connection portion between the first air passage 20 and the liquid-phase fuel passage 22.

### Second Embodiment

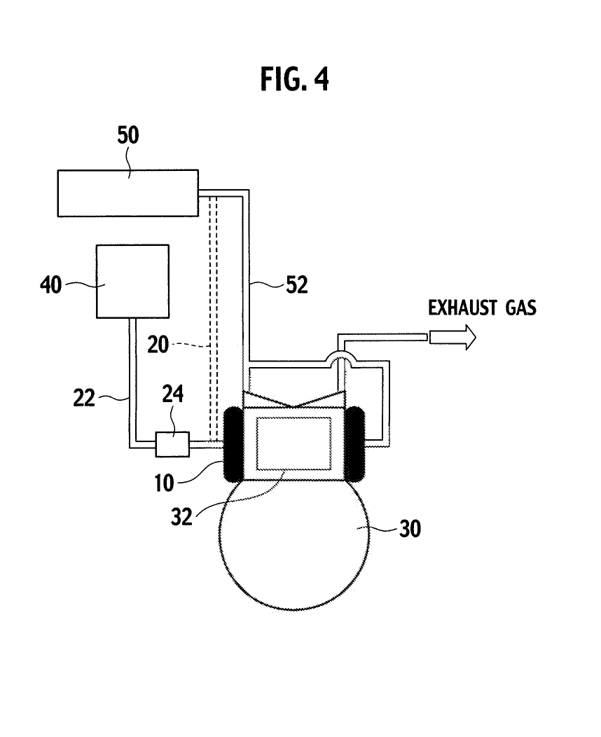

FIG. 4 is a schematic view showing a configuration of a second embodiment of the internal combustion engine in the present invention. As shown in FIG. 4, the internal combustion engine of this embodiment includes: the octane number-increasing catalytic device 10 having the octane number-increasing catalyst; the air passage 20 and a compressor 50, which are the air supply devices; the engine 30; and the fuel tank 40. In the fuel tank 40, there is stored the raw fuel, which serves as the liquid-phase fuel, such as light oil, gasoline, and alcohol fuel including biomass ethanol and the like. The compressor 50 is connected also to the second air passage 52, and supplies compressed air to the engine 30. Moreover, in the internal combustion engine of this embodiment, the octane number-increasing catalytic device 10 is provided in the vicinity of a water jacket 32 that is provided above the engine 30 and filled with coolant to be circulated to a cylinder block and a cylinder head. The water jacket 32 is heated by heat energy of the engine. Accordingly, the octane number-increasing catalyst 12 is provided in the vicinity of the water jacket 32, whereby the catalyst 12 is warmed by heat transferred from the water jacket 32, thus making it possible to enhance catalyst activity of rhodium.

A description will be made of actions of this embodiment. In the internal combustion engine of this embodiment, first, the liquid-phase fuel is supplied to the vaporizer 24 through the liquid-phase fuel passage 22. Then, the liquid-phase fuel is vaporized by the vaporizer 24, and thereafter, is supplied to the octane number-increasing catalytic device 10. Moreover, the air (oxygen) is supplied to the octane number-increasing catalytic device 10 from the first air passage 20. The supplied liquid-phase fuel and oxygen contact rhodium of the octane number-increasing catalyst 12 heated by the water jacket 32, whereby the liquid-phase fuel is converted, and the octane number thereof is increased. The liquid-phase fuel of which octane number is increased is mixed with the air supplied from the second air passage 52, and is then supplied to the engine 30. In the internal combustion engine of this embodiment, the octane number of the liquid-phase fuel is increased more than in the first embodiment by the heated octane number-increasing catalytic device 10. Accordingly, the knocking can be suppressed, thus making it possible to enhance the combustion characteristics.

### Third Embodiment

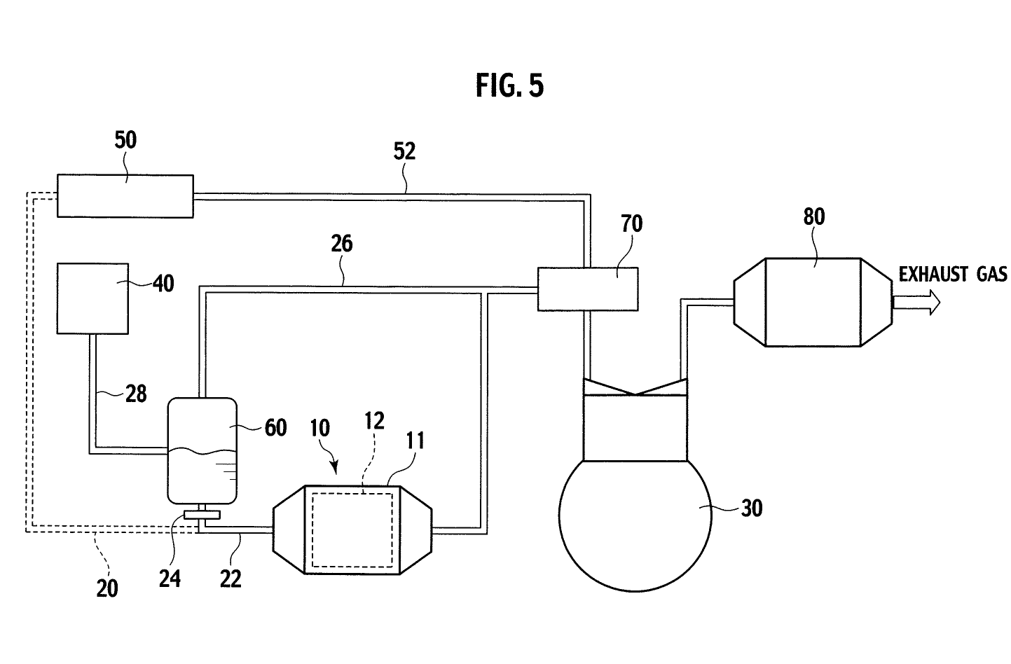

FIG. 5 is a schematic view showing a configuration of a third embodiment of the internal combustion engine in the present invention. As shown in FIG. 5, the internal combustion engine of this embodiment includes: the octane number-increasing catalytic device 10 having the octane number-increasing catalyst 12; the air passage 20 and the compressor 50, which are the air supply devices; the engine 30; the fuel tank 40; a gas-liquid separator 60; a vaporizer 70; and an exhaust catalytic converter 80. In the fuel tank 40, as the raw fuel, there is stored light oil, gasoline, or alcohol fuel including biomass ethanol and the like. The gas-liquid separator 60 has a function to separate the raw fuel into the gas-phase fuel and the liquid-phase fuel. A conventional one can be used as the gas-liquid separator 60. However, the gas-liquid separator 60 may serve also as the fuel tank. Specifically, the gas-phase fuel can be taken out of an upper portion of the fuel tank, and the liquid-phase fuel can be taken out of a lower portion thereof. Such a configuration in which a spatial portion of the fuel tank is made to function as the gas-liquid separator is adopted as described above, whereby the number of parts can be reduced. The vaporizer 70 has functions to mix the gas-phase fuel, the liquid-phase fuel and the air, and to further vaporize a resultant mixture. An apparatus that vaporizes the liquid-phase fuel by heat of exhaust gas can be used as the vaporizer 70. The exhaust catalytic converter 80 has functions to oxidize hydrocarbon and carbon monoxide in the exhaust gas exhausted from the engine 30 and convert the hydrocarbon and the carbon monoxide into carbon dioxide and water, and further to reduce a nitrogen oxide in the exhaust gas and convert the nitrogen oxide into nitrogen.

A description will be made of actions of this embodiment. In the internal combustion engine of this embodiment, first, the raw fuel is supplied from the fuel tank 40 through a raw fuel passage 28 to the gas-liquid separator 60. The supplied raw fuel is separated into the gas-phase fuel and the liquid-phase fuel in the gas-liquid separator 60. When the raw fuel is gasoline, the gasoline is easily separated into a gas-phase component and a liquid-phase component since the gasoline is a petroleum fraction in which a boiling point range is 300 to 490 K, and a plurality of components such as paraffin, olefin and aromatic hydrocarbon are contained therein. The separated gas-phase fuel is supplied through a gas-phase fuel passage 26 to the vaporizer 70. Next, the separated liquid-phase fuel is supplied through the liquid-phase fuel passage 22 to the vaporizer 24. Then, the liquid-phase fuel is vaporized by the vaporizer 24, and thereafter, is supplied to the octane number-increasing catalytic device 10. Moreover, the air (oxygen) is supplied to the octane number-increasing catalytic device 10 from the first air passage 20. The supplied liquid-phase fuel and oxygen contact rhodium of the octane number-increasing catalyst 12, whereby the liquid-phase fuel is converted, and the octane number thereof is increased. The liquid-phase fuel of which octane number is increased is supplied to the vaporizer 70 through the liquid-phase fuel passage 22. Meanwhile, the air compressed by the compressor 50 is also supplied to the vaporizer 70 through the second air passage 52. Thereafter, the liquid-phase fuel of which octane number is increased, the gas-phase fuel, and the air are mixed in the vaporizer 70, followed by vaporization. Then, mixed gas of the vaporized liquid-phase fuel, gas-phase fuel and air is supplied to the engine 30. The mixed gas is burned in the engine 30, and becomes the exhaust gas. The exhaust gas passes through the exhaust catalytic converter 80, is purified there, and is discharged to the outside.

Note that it is preferable to supply the liquid-phase fuel of which octane number is increased and the gas-phase fuel to the engine 30 in response to an operational situation thereof in the following manner. First, in a range where a load on the engine 30 is low and the number of revolutions thereof is small (that is, a range for use in a normal operation), the gas-phase fuel is supplied to the engine 30. Since characteristics of the gas-phase fuel are lean burn and do not cause the knocking under high compression, use of the gas-phase fuel makes it possible to enhance fuel consumption to a large extent. Next, in a range where the load on the engine is high, the liquid-phase fuel is supplied to the engine 30. When the gas-phase fuel is used in this range, intake charge efficiency is decreased, resulting in a decrease of an engine output. Therefore, in the range where the load is high, it is preferable to use the liquid-phase fuel, of which octane number is high. In a medium range excluding the ranges where the load is low and high, the gas-phase fuel and the liquid-phase fuel are concurrently used. Specifically, the gas-phase fuel is mainly used, and the liquid-phase fuel is supplied as compensation for a shortage. The gas-phase fuel and the liquid-phase fuel are used properly according to the operational situation as described above, whereby the high compression can be realized in any of the ranges, and by the enhancement of thermal efficiency, the fuel consumption and the output can be enhanced to a large extent. Moreover, the gas-phase fuel is used during such a low-load operation, and the liquid-phase fuel is used during such a high-load operation, whereby, in particular, the enhancement of the fuel consumption during the low-load operation and the enhancement of the output during the high load operation can be made compatible with each other at a high level. Note that supply amounts of the liquid-phase fuel and the gas-phase fuel to the engine 30 can be controlled by valves (not shown) provided individually on the gas-phase fuel passage 26 and the liquid-phase fuel passage 22.

### Fourth Embodiment

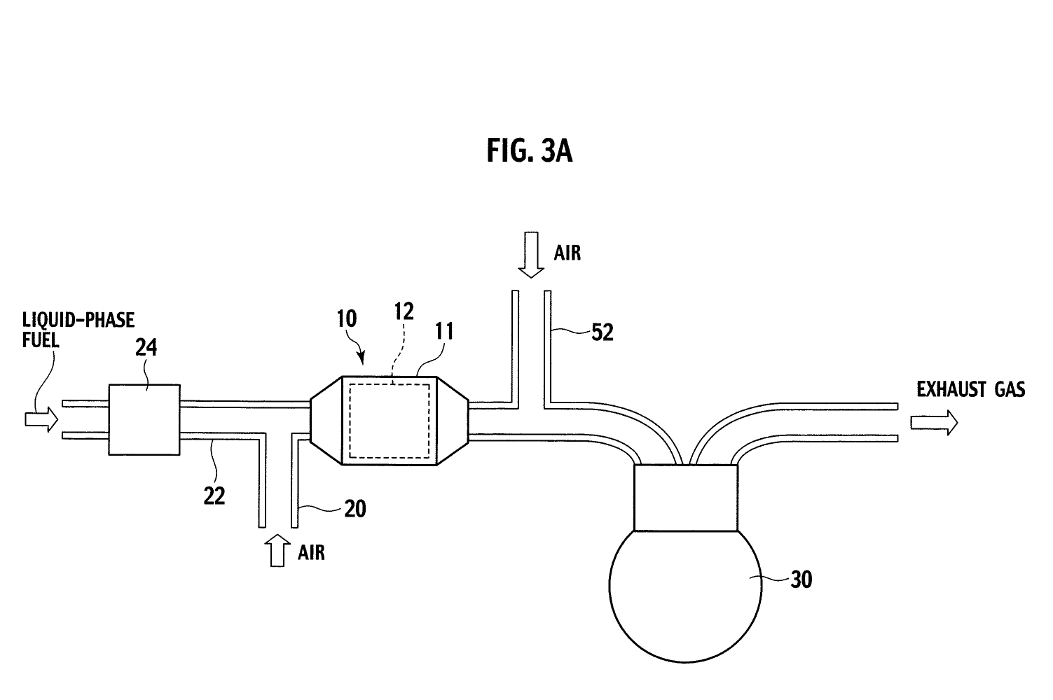

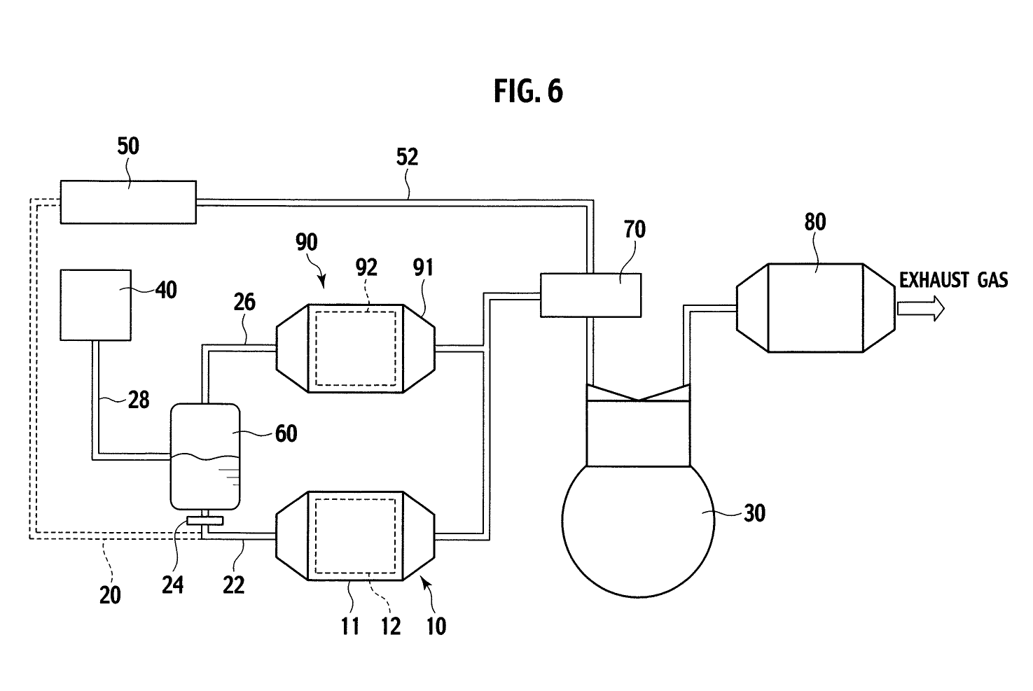

FIG. 6 is a schematic view showing a configuration of a fourth embodiment of the internal combustion engine in the present invention. As shown in FIG. 6, in the internal combustion engine of this embodiment, a molecular weight-increasing catalytic device 90 is provided on the gas-phase fuel passage 26 in the internal combustion engine of the third embodiment shown in FIG. 5. In an inside of the molecular weight-increasing catalytic device 90, there is provided a molecular weight-increasing catalyst 92 that increases the molecular weight of the gas-phase fuel. The molecular weight-increasing catalyst 92 is a catalyst containing platinum and zinc as catalyst components. Moreover, as shown in FIG. 2, it is preferable that platinum and zinc be coated on the inner walls of the monolith substrate. By using the monolith substrate, a contact area between the gas-phase fuel and the catalyst components is increased to a large extent, whereby the molecular weight of the gas-phase fuel can be increased efficiently.

A description will be made of actions of this embodiment. In the internal combustion engine of this embodiment, first, the raw fuel supplied from the fuel tank 40 to the gas-liquid separator 60 is separated into the gas-phase fuel and the liquid-phase fuel in the gas-liquid separator 60. Moreover, under the presence of oxygen compressed by the compressor 50 and supplied to the air fuel passage 20, the octane number of the liquid-phase fuel is increased by the octane number-increasing catalyst 12 in the octane number-increasing catalytic device 10 provided downstream of the gas-liquid separator 60. Meanwhile, the molecular weight of the gas-phase fuel is increased by the molecular weight-increasing catalyst 92 in the molecular weight-increasing catalytic device 90 provided downstream of the gas-liquid separator 60. Furthermore, the liquid-phase fuel of which octane number is increased and the gas-phase fuel of which molecular weight is increased are supplied to the vaporizer 70. Meanwhile, the air (oxygen) compressed by the compressor 50 is also supplied to the vaporizer 70. Still further, mixed gas of the liquid-phase fuel of which octane number is increased, the gas-phase fuel of which molecular weight is increased and oxygen (external air) is vaporized in the vaporizer 70. Subsequently, the mixed gas thus vaporized is supplied to the engine 30. The mixed gas is burned in the engine 30, and becomes the exhaust gas. The exhaust gas passes through the exhaust catalytic converter 80, is purified there, and is discharged to the outside.

In the internal combustion engine of this embodiment, the molecular weight of the gas-phase fuel is increased by the molecular weight-increasing catalyst 92. Specifically, molecules of low-molecular-weight hydrocarbon in which a carbon number is any of 1 to 4 are bonded together, whereby the low-molecular-weight hydrocarbon can be converted into hydrocarbon in which a carbon number is any of 6 to 10. In such a way, not only the octane number of the liquid-phase fuel but also the octane number of the gas-phase fuel is increased, thus making it possible to enhance the combustion characteristics, for example, to enable the suppression of the knocking, and the like.

### Fifth Embodiment

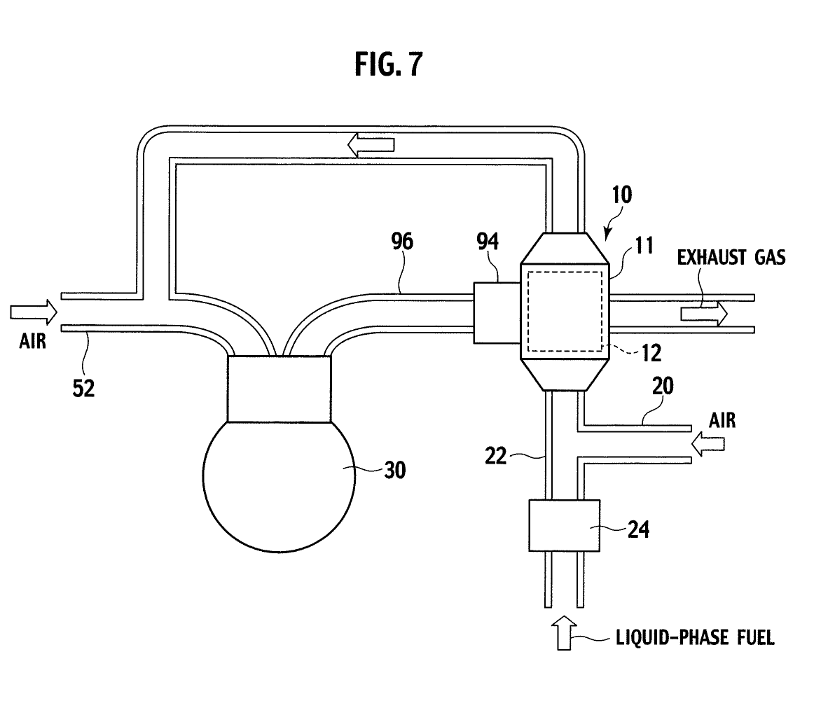

FIG. 7 is a schematic view showing a configuration of a fifth embodiment of the internal combustion engine in the present invention. As shown in FIG. 7, the internal combustion engine of this embodiment includes: the octane number-increasing catalytic device 10 having the octane number-increasing catalyst 12; the first air passage 20 as a part of the air supply device; the engine 30; and a heat exchanger 94. The heat exchanger 94 is provided on an exhaust pipe 96 of the internal combustion engine, collects the waste heat of the exhaust gas, and heats the octane number-increasing catalytic device 10 connected thereto. The air passage 20 supplies the air containing oxygen to the liquid-phase fuel supplied to the octane number-increasing catalytic device 10. Then, in the octane number-increasing catalytic device 10 heated by the heat exchanger, the octane number of the liquid-phase fuel is increased by the octane number-increasing catalyst 12. Subsequently, the liquid-phase fuel of which octane number is increased and the air are supplied to the engine 30.

In the internal combustion engine of this embodiment, the octane number-increasing catalyst 12 in the octane number-increasing catalytic device 10 is heated by the heat transferred from the heat exchanger, and accordingly, the catalyst activity of rhodium can be enhanced. Therefore, the octane number of the liquid-phase fuel is increased more than in the first embodiment by the heated octane number-increasing catalytic device 10. Accordingly, the knocking can be suppressed, thus making it possible to enhance the combustion characteristics.

### Sixth Embodiment

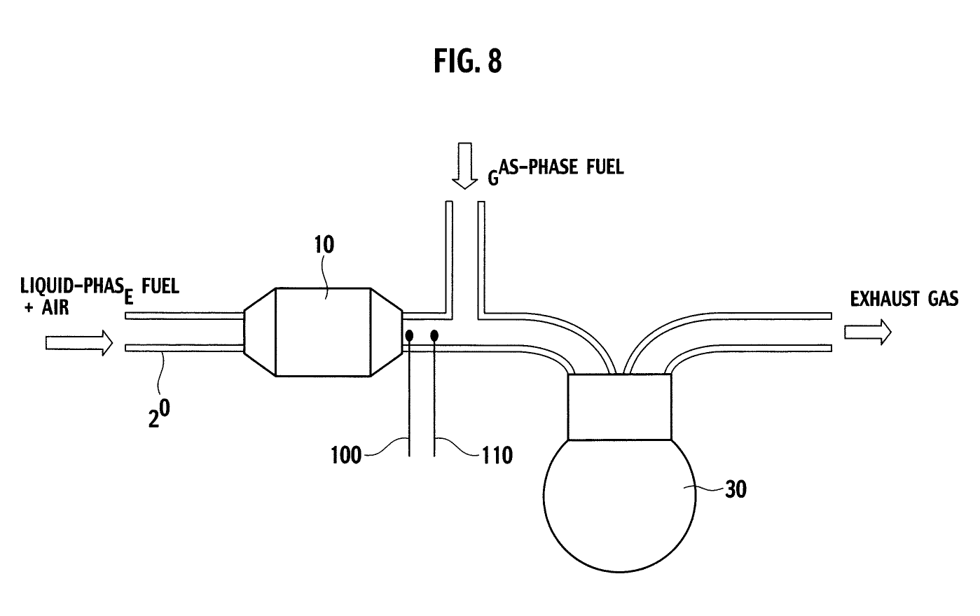

FIG. 8 is a schematic view showing a part of a configuration of a sixth embodiment of the internal combustion engine in the present invention. As shown in FIG. 8, the internal combustion engine of this embodiment has a similar configuration to that of the first embodiment except for including a carbon dioxide detector 100 and a temperature sensor 110 on the downstream side of the octane number-increasing catalytic device 10.

The fuel reformer of the present invention is one that increases the octane number of the liquid-phase fuel under the presence of oxygen. Moreover, the octane number-increasing catalyst for use in the fuel reformer is one that contains rhodium. Rhodium has not only property to increase the octane number of the liquid-phase fuel under the presence of the hydrogen but also property to undesirably oxidize the liquid-phase fuel when oxygen is excessively present. Hence, in the internal combustion engine of this embodiment, the carbon dioxide detector is provided downstream of the octane number-increasing catalytic device 10, and an amount of the carbon dioxide is then detected. Then, the following procedure is preferably adopted. Specifically, when the amount of the carbon dioxide exceeds the predetermined value (3 vol %), it is determined that the reaction of oxidizing the liquid-phase fuel is accelerated rather than the reaction of increasing the octane number thereof. Subsequently, a control is performed, which is to reduce the amount of the air (oxygen) introduced into the octane number-increasing catalytic device 10. The above is the procedure to be preferably adopted. In such a way, the amount of oxygen in the octane number-increasing catalytic device 10 is reduced, and such an oxidation reaction (a combustion reaction) of the liquid-phase fuel is prevented, whereby the liquid-phase fuel of which octane number is increased can be supplied to the engine.

Moreover, when the oxidation reaction of the liquid-phase fuel occurs, an exothermic reaction is progressing. Accordingly, the temperature of the gas discharged from the octane number-increasing catalytic device 10 becomes higher than usual. Hence, the following procedure is preferably adopted. Specifically, when an outlet temperature of the octane number-increasing catalytic device 10, which is measured by the temperature sensor, exceeds a predetermined value (for example, 700° C.), it is determined that the reaction of oxidizing the liquid-phase fuel is accelerated rather than the reaction of increasing the octane number thereof. Subsequently, the control is performed, which is to reduce the amount of the air (oxygen) introduced into the octane number-increasing catalytic device 10. The above is the procedure to be preferably adopted.

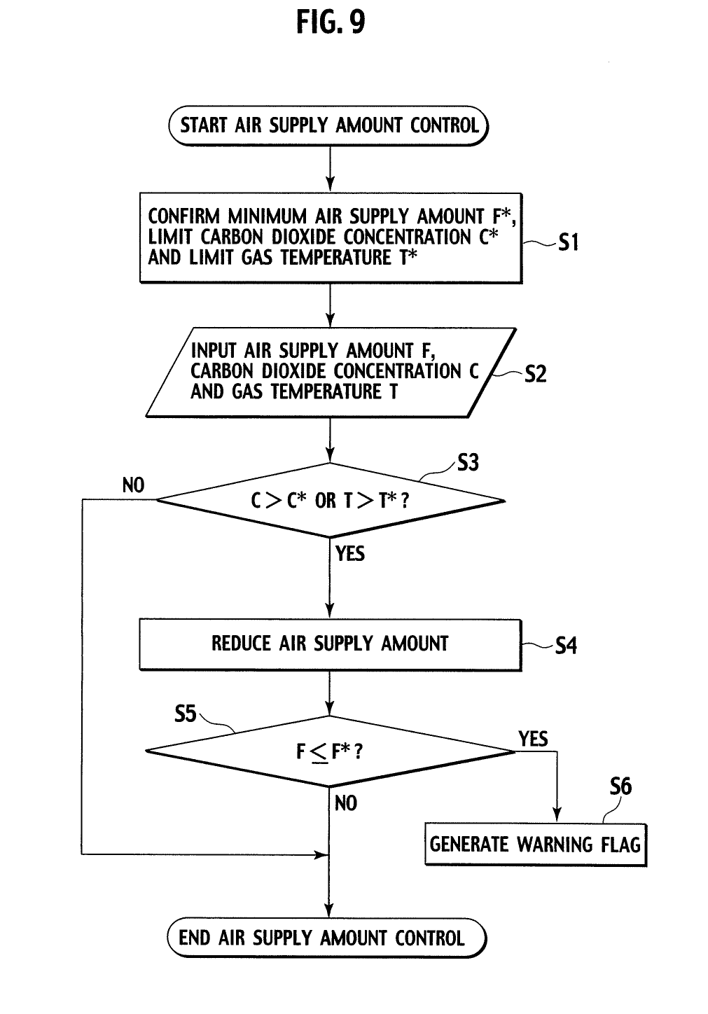

FIG. 9 is a flowchart explaining an example of such an oxygen supply amount control in the sixth embodiment. In this embodiment, first, as shown in step 1 (S1), a minimum air supply amount (F*) (minimum oxygen supply amount (F*)), a limit carbon dioxide concentration (C*) and a limit gas temperature (T*) are preset. The minimum air supply amount (F*) is a minimum air supply amount at which rhodium causes the reaction of increasing the octane number of the liquid-phase fuel. The limit carbon dioxide concentration (C*) is the above-mentioned predetermined value of the carbon dioxide concentration at the outlet of the octane number-increasing catalytic device 10. Moreover, the limit gas temperature (T*) is also the above-mentioned predetermined value of the gas temperature at the outlet of the octane number-increasing catalytic device 10.

Next, in step 2 (S2), the air supply amount (F) (oxygen supply amount (F)), the carbon dioxide concentration (C) and the gas temperature (T) are detected. The air supply amount (F) can be detected by an air supply amount detector (oxygen supply amount detector), such as a flowmeter, provided upstream of the octane number-increasing catalytic device 10. Moreover, the carbon dioxide concentration (C) and the gas temperature (T) can be detected by the carbon dioxide detector 100 and the temperature sensor 110, which are provided downstream of the octane number-increasing catalytic device 10 as described above.

Next, in step 3 (S3), it is determined whether or not the carbon dioxide concentration (C) exceeds the limit carbon dioxide concentration (C*), or it is determined whether or not the gas temperature (T) exceeds the limit gas temperature (T*). When both of the carbon dioxide concentration (C) and the gas temperature (T) do not exceed the limit carbon dioxide concentration (C*) and the limit gas temperature (T*), it is determined there is nothing abnormal in such an octane-number increasing reaction. Subsequently, the air supply amount control is ended, and the operation is returned to the normal operation. However, when either of the carbon dioxide concentration (C) and the gas temperature (T) exceeds the limit carbon dioxide concentration (C*) or the limit gas temperature (T*), it is determined that abnormality occurs in the octane-number increasing reaction, and that the oxidation reaction is progressing. Subsequently, the air supply amount (F) is reduced in order to suppress the oxidation reaction (S4).

Next, in step 5 (S5), it is determined whether or not the air supply amount (F) exceeds the minimum air supply amount (F*). When the air supply amount (F) exceeds the minimum air supply amount (F*), it is determined that there is nothing abnormal in the octane-number increasing reaction. Subsequently, the air supply amount control is ended, and the operation is returned to the normal operation. However, when it is determined that the air supply amount (F) is equal to or less than the minimum air supply amount (F*), the control proceeds to step 6, where the supply of the air to the octane number-increasing catalytic device 10 is stopped. Moreover, a warning flag is generated, and a driver is notified that there is something abnormal in the octane number-increasing catalytic device 10. Specifically, at the stage where the control proceeds to step 6, even if the air supply amount (F) is reduced to the minimum air supply amount (F*) or less, there is a possibility that some abnormality may have occurred since either of the carbon dioxide concentration (C) and the gas temperature (T) exceeds the limit carbon dioxide concentration (C*) or the limit gas temperature (T*). Hence, the driver notified of the abnormality checks the system, thus making it possible to find the abnormality of the fuel reformer at an early stage, and to repair the fuel reformer.

Note that, in the above-described embodiment, the carbon dioxide detector is provided as means for detecting the oxidation reaction of the liquid-phase fuel. However, since carbon monoxide and aldehyde are also generated by the oxidation reaction of the liquid-phase fuel, the carbon monoxide detector or the aldehyde detector may be used. Moreover, the carbon dioxide detector, the carbon monoxide detector and the aldehyde detector may be used in combination.

Furthermore, in the above-described embodiment, the temperature sensor is placed downstream of the octane number-increasing catalytic device 10; however, the temperature sensor may be provided in the inside of the octane number-increasing catalyst 12 so as to measure a temperature of the octane number-increasing catalyst 12.

A description will be made below more in detail of the present invention by Example; however, the present invention is not limited to such Example.

### (Fabrication of Octane Number-Increasing Catalyst)

Aluminum oxide in which a BET specific surface area was 100 m²/g was impregnated into an aqueous solution of rhodium nitrate, in which a content of rhodium metal was 15 wt %, followed by drying and baking, whereby powder of rhodium-supported aluminum oxide was obtained. A content of rhodium in the powder was 2.0 wt %.

Alumina sol was added as an application aid to rhodium-supported aluminum oxide thus obtained, and was dispersed thereinto for an hour by a ball mill, whereby slurry was obtained. Thereafter, the slurry was applied on a cordierite-made honeycomb substrate (volume: 0.12 L) having 400 cells per square inch so that an applied amount of the powder could be 7.2 g, followed by drying and baking, whereby a rhodium-supported aluminum oxide catalyst was obtained.

### (Performance Evaluation)

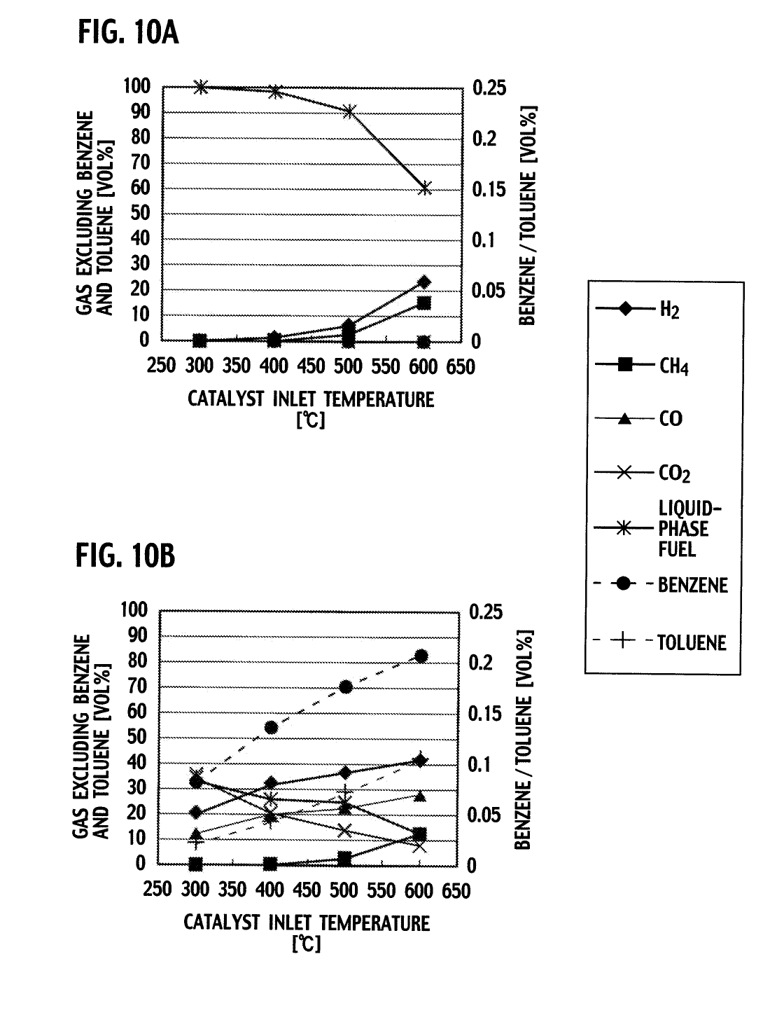

Vaporized isooctane was supplied to 0.006 L of the above-described catalyst at a flow rate of 0.3 mL per minute under an atmosphere of nitrogen gas supplied at a flow rate of 0.5 L per minute. Then, an atmospheric temperature was adjusted, whereby temperature characteristics of the catalyst were confirmed. Specifically, gas at an outlet of the catalyst was analyzed by gas chromatography at each temperature. Obtained results are shown in FIG. 10A.

Moreover, vaporized isooctane was supplied to 0.006 L of the above-described catalyst at a flow rate of 0.3 mL per minute under an atmosphere of air supplied at a flow rate of 0.5 L per minute. Then, an atmospheric temperature was adjusted, whereby temperature characteristics of the catalyst were confirmed. Specifically, gas at the outlet of the catalyst was analyzed by the gas chromatography at each temperature. Obtained results are shown in FIG. 10B.

When FIG. 10A and FIG. 10B are compared with each other, it is understood from FIG. 10B that the supply of a small amount of oxygen allows a part of the isooctane (the liquid-phase fuel) to become aromatic hydrocarbon such as benzene and toluene, whereby the octane number is increased. Moreover, it is understood from FIG. 10B that, though the carbon dioxide is secondary generated, an amount thereof is reduced as the temperature rises.

The entire content of a Japanese Patent Application No. P2007-070470 with a filing date of Mar. 19, 2007 is herein incorporated by reference.

Although the invention has been described above by reference to certain embodiments of the invention, the invention is not limited to the embodiments described above and modifications may become apparent to these skilled in the art, in light of the teachings herein. The scope of the invention is defined with reference to the following claims.

What is claimed is:

1. An octane number-increasing catalyst, wherein the octane number-increasing catalyst increases an octane number of liquid-phase fuel under presence of oxygen.

2. The octane number-increasing catalyst according to claim 1, comprising:
rhodium.

3. The octane number-increasing catalyst according to claim 1, comprising:
rhodium; and
a base material composed of at least one selected from the group consisting of silica, alumina, ceria, zirconia, titania and magnesia, in which rhodium is supported on the base material.

4. The octane number-increasing catalyst according to claim 1, comprising:
a composite oxide of rhodium and at least a metal oxide selected from the group consisting of silica, alumina, ceria, zirconia, titania and magnesia.

5. A fuel reformer of an internal combustion engine that operates accompanied with generation of heat, the fuel reformer comprising:
an octane number-increasing catalytic device comprising the octane number-increasing catalyst according to claim 1; and
an oxygen supply device that supplies oxygen to the octane number-increasing catalytic device.

6. The fuel reformer according to claim 5,
wherein the oxygen supply device supplies oxygen to the octane number-increasing catalytic device so that a ratio of a number of oxygen molecules with respect to a number of molecules of liquid-phase fuel (number of oxygen molecules/number of molecules of liquid-phase fuel) is within a range from 0.005 to 1.0.

7. The fuel reformer according to claim 5, further comprising:
a gas-liquid separator that separates raw fuel into gas-phase fuel and liquid-phase fuel; and
a molecular weight-increasing catalytic device comprising a molecular weight-increasing catalyst that increases weight of the gas-phase fuel,
wherein the octane number-increasing catalytic device and the molecular weight-increasing catalytic device are provided downstream of the gas-liquid separator.

8. The fuel reformer according to claim 5, further comprising:
at least one detector selected from the group consisting of a carbon dioxide detector, a carbon monoxide detector and an aldehyde detector, the detector being provided downstream of the octane number-increasing catalytic device.

9. The fuel reformer according to claim 8,
wherein the carbon dioxide detector is a carbon dioxide detector of an infrared absorption type or a carbon dioxide detector of a solid electrolyte type.

10. The fuel reformer according to claim 8,
wherein the oxygen supply device reduces an oxygen supply amount when the carbon dioxide detector determines that a carbon dioxide concentration detected thereby is a limit carbon dioxide concentration.

11. The fuel reformer according to claim 10,
wherein the limit carbon dioxide concentration is 3 vol % or less on an outlet side of the octane number-increasing catalytic device.

12. The fuel reformer according to claim 8, further comprising:
an oxygen supply amount detector that detects an amount of oxygen supplied to the octane number-increasing catalytic device, the oxygen supply amount detector being provided upstream of the octane number-increasing catalytic device,
wherein the oxygen supply device stops reducing the oxygen supply amount when the oxygen supply amount detector determines that the amount of oxygen supplied by the oxygen supply device is less than a limit oxygen supply amount.

13. The fuel reformer according to claim 5, further comprising:
a temperature sensor provided downstream of the octane number-increasing catalytic device.

14. The fuel reformer according to claim 5, further comprising:
a heat exchanger that collects heat generated by the internal combustion engine and heats the octane number-increasing catalytic device.

15. An internal combustion engine, comprising:
a fuel reformer according to claim 5.
